(19) United States
(12) Patent Application Publication
(10) Pub. No.: US 2018/0208116 A1
(43) Pub. Date: Jul. 26, 2018

(54) SYSTEM AND METHODOLOGY FOR VEHICLE SENSOR ADJUSTMENT

(71) Applicant: International Business Machines Corporation, Armonk, NY (US)

(72) Inventors: Heidi Lagares-Greenblatt, Pittsburgh, PA (US); Jenny S. Li, Southbury, CT (US); Xinlin Wang, Costa Mesa, CA (US)

(21) Appl. No.: 15/416,078

(22) Filed: Jan. 26, 2017

(51) Int. Cl. B60R 1/00; B60Q 9/00; G06K 9/00

(52) U.S. Cl. CPC B60R 1/002; B60Q 9/00; B60R 2300/8026; B60R 2300/205; G06K 9/00805

(57) ABSTRACT

The disclosure is directed to methods and systems for modifying a vehicle periphery. These methods and systems include receiving a notification that an attachment is placed on the vehicle, detecting, with one or more sensors located in or on the vehicle, the location and size of the attachment on the vehicle, forming an attachment periphery of the attachment's size and location, forming a representation of the attachment periphery relative to the vehicle periphery and monitoring, with the one or more sensors, the surroundings of the vehicle to determine if an obstacle is within a predetermined distance of the attachment periphery or the vehicle periphery.

The present application relates generally to computers, and computer applications, and more particularly to computer-implemented methods and systems to adjust a vehicle's sensors.

### BACKGROUND

Typical backup cameras and distance sensors on vehicles, including automobiles, do not adjust their operation based on an attachment to the vehicle that extends from the rear of the vehicle, from the roof of the vehicle, etc. For typical backup cameras, their view of the area behind a vehicle can be obscured or blocked. For typically distance sensors, they may sense the distance between the sensor and the attachment, not a distance between the automobile and an external structure or person and not a distance between the attachment and that external structure or person.

Known backup cameras and distance sensors on vehicles can monitor surroundings, but cannot accommodate measurement of any attachment to the vehicle.

### BRIEF SUMMARY

One embodiment of a computer implemented method for modifying a vehicle periphery includes the steps of receiving a notification that an attachment is placed on the vehicle, detecting, with one or more sensors located in or on the vehicle, the location and size of the attachment on the vehicle, forming an attachment periphery of the attachment's size and location, forming a representation of the attachment periphery relative to the vehicle periphery and monitoring, with the one or more sensors, the surroundings of the vehicle to determine if an obstacle is within a predetermined distance of the attachment periphery or the vehicle periphery.

A system that includes one or more processors operable to perform one or more methods described herein also may be provided.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1A is a graphic illustration of several vehicles, two of which having an attachment, in accordance with at least one embodiment of the present invention.

FIG. 1B is a graphic illustration of a vehicle that includes a plurality of sensors in accordance with at least one embodiment of the present invention.

FIG. 2a and FIG. 2b are graphic illustrations of a vehicle and a vehicle with an attachment in accordance with at least one embodiment of the present invention.

FIG. 3 is a flow diagram illustrating a method of modifying a vehicle periphery according to an embodiment of the present invention.

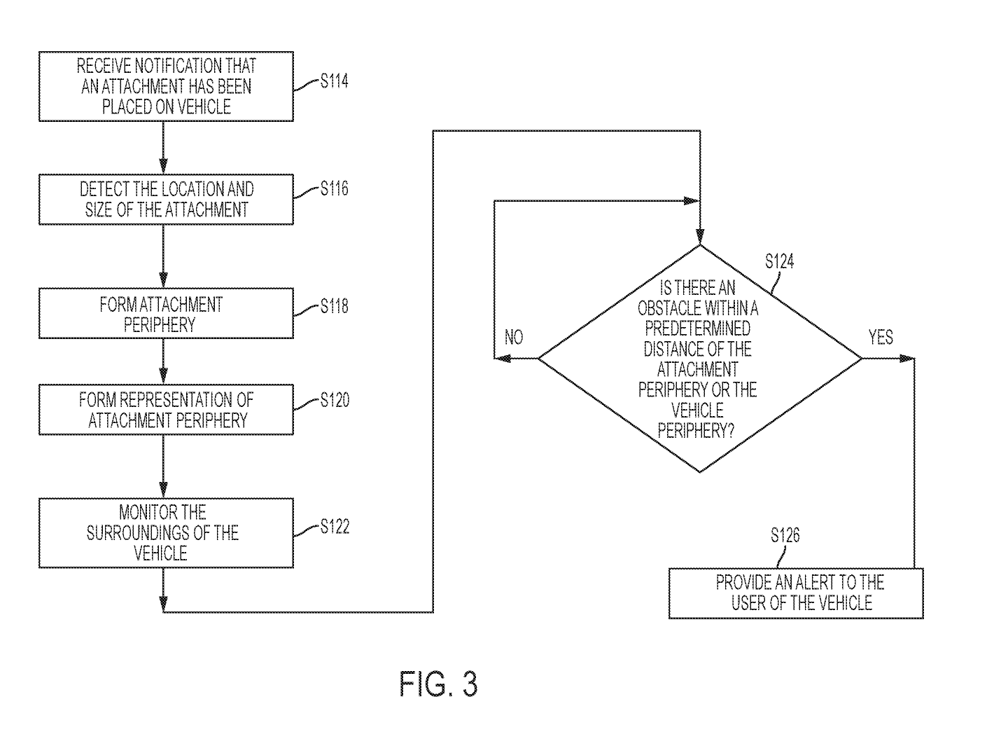

FIG. 4 depicts a cloud computing environment according to an embodiment of the present invention.

FIG. 5 depicts abstraction model layers according to an embodiment of the present invention.

FIG. 6 illustrates a schematic of an example computer or processing system according to an embodiment of the present invention.

### DETAILED DESCRIPTION

The disclosure is directed to systems and methods to include objects attached to a vehicle when determining possibility of impact between the vehicle or object and an obstacle.

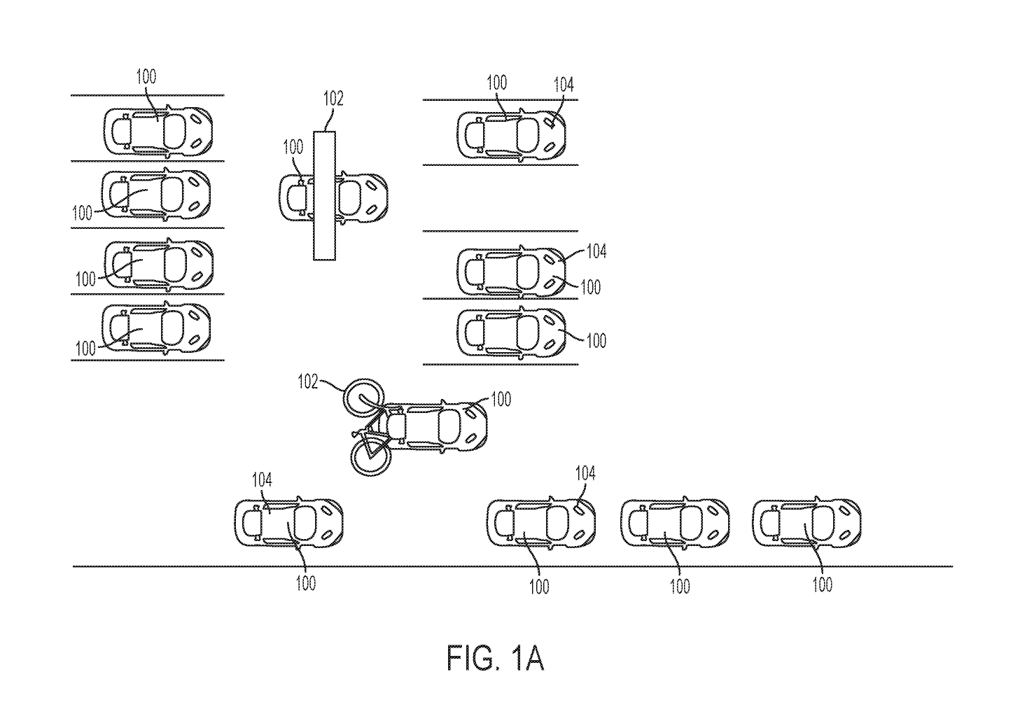

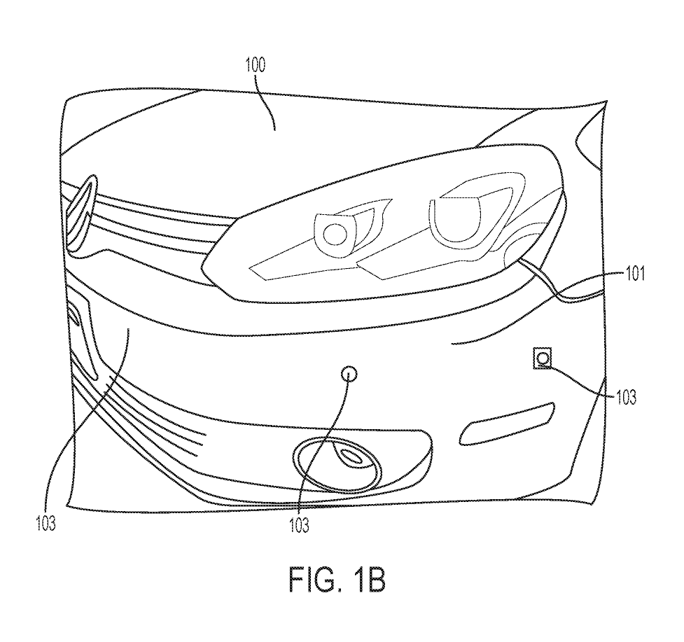

FIG. 1A is an illustration of a number of vehicles 100. Two of the vehicles include an attachment 102 that has been placed on the exterior of the vehicle 100. One attachment 102 is shown placed on a roof of a vehicle 100 (for example lumber) and one attachment 102 is shown placed on a rear portion of a vehicle 100 (for example a bicycle). In other embodiments, the attachment 102 can be of any size and any configuration on, or mounted to, the exterior of the vehicle 100. Also, the attachment can be partially within the vehicle 100 and partially extending from the vehicle 100, such as a piece of wood extending from a rear window of the vehicle, or a ladder extending from the bed of a pickup truck vehicle. This portion of the attachment extending from the vehicle would be considered as being placed “on” the vehicle for purposes of this application.

One or more processors within the vehicle 100 can be notified that an attachment is placed on the vehicle 100. In one embodiment a notification can be received by the one or more processors by a user of the vehicle 100 due to an input from the user. In another embodiment one or more sensors 103 in or on the vehicle 100 can detect the presence of an attachment on the vehicle and automatically provide a notification that an attachment is placed on the vehicle.

In one embodiment, illustrated in FIG. 1B, sensors 103 are shown in a portion of a vehicle 100. In this embodiment sensors 103 are located in a bumper 101 of vehicle 100, but in other embodiments the one or more sensors 103 can be located in or on any portion of the vehicle 100. Also in this embodiment sensors 103 are formed into the bumper 101 by the manufacturer, but in other embodiments various sensors 103 can be placed on or in any portion of vehicle 100 after manufacture of vehicle 100.

Each vehicle 100 includes one or more sensors 103 that are in or on the vehicle 100′s periphery. These sensors can include any element that is capable of sensing a distance between itself and any obstacles external to the vehicle 100. Some examples of these sensors are near field communication (NFC) sensors, image sensors, infrared sensors, ultrasonic sensors, radar sensors and electromagnetic sensors.

Referring again to FIG. 1A, obstacles 104 are other vehicles, but, in other embodiments obstacles can be people and/or other objects such as trees, curbs, buildings, railings, etc. that the vehicle 100 and/or the attachment 102 can impact. Although obstacles 104 are shown as being horizontally spaced from the vehicle 100, in other embodiments obstacles can be any item that can be vertically above the vehicle 100 and/or the obstacle 104, such as underpasses, parking garages, tree branches,

Further, the vehicles 100 shown in FIG. 1A are consumer automobiles, but in other embodiments, the vehicle 100 can be any automobile, including trucks, trains, buses, emergency vehicles, motorcycles, marine vehicles, aircraft and any other automobile that is capable of having an attachment 102 secured to it, including any vehicle that is semi-autonomous or fully autonomous.

One or more processors within the vehicle 100 receive data from the one or more sensors 103 to form a vehicle periphery, which is data in three dimensions regarding the dimensions of each portion of the vehicle periphery. To provide data, each of the one or more sensors 103 includes a transmitting element and a receiving element, with the transmitting element providing a signal, such as a radio frequency electromagnetic energy. The receiving element receives the signal, in this example an echo of the radio frequency electromagnetic energy. Each of the one or more sensors 103 can compare the transmitted and received signals to determine the range (from time of flight, or by using time or frequency domain reflectometry) and the speed (typically by analyzing the Doppler shift of the echoed energy) of the target from which the echoes were transmitted.

For determining the exterior dimensions of the vehicle 100, each of the one or more sensors 103 can determine the echo with the highest range, and determine the length between each of the one or more sensors and the furthest exterior point of the vehicle 100 in each direction. These number of data points for each of the one or more sensors 103 are three dimensional spatial data coordinates having XYZ values representing a virtual cloud of 3D point data. Each of the 3D point data can be combined by one or more processors within the vehicle 100 to form a 3D representation of the vehicle periphery. This vehicle periphery can be formed each time a vehicle is used, following the prompt of a user, or one time and stored within a storage device within the vehicle or accessible by the vehicle.

The one or more processors within the vehicle 100 can also receive data from the one or more sensors 103, using the method discussed above, of the size and location of any attachment 102 placed on the vehicle 100. Based on this attachment data the one or more processors can form an attachment periphery, which is data in three dimensions regarding the dimensions of each portion of the attachment, or just the portions of the attachment that extend furthest from the vehicle 100, using the method discussed above to from the vehicle periphery.

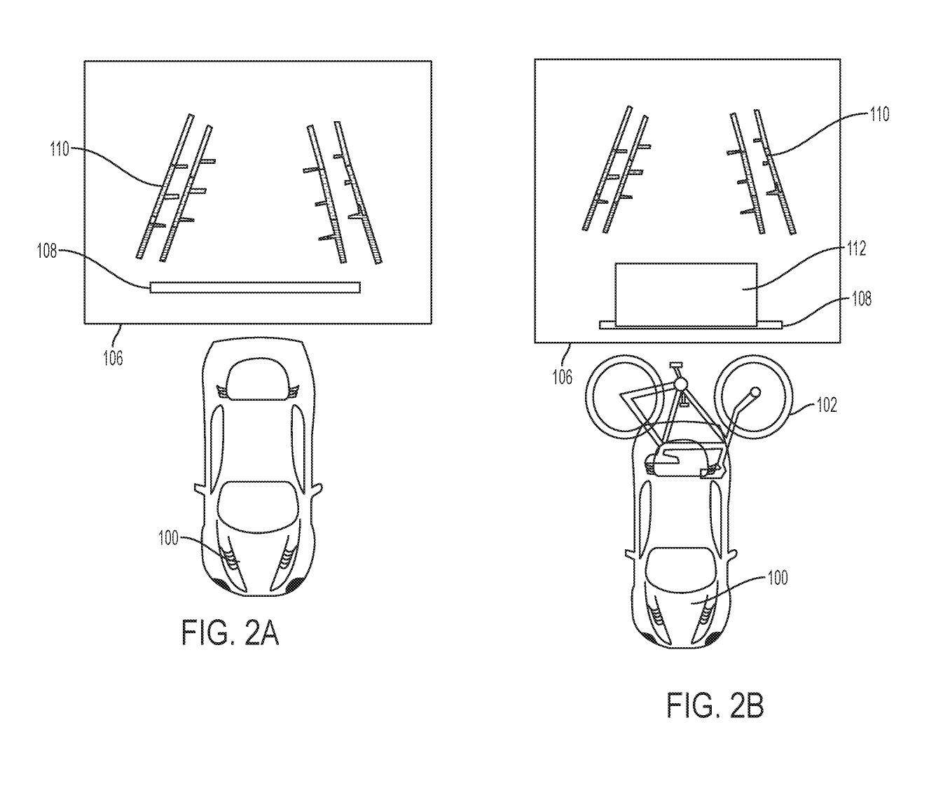

Referring to FIG. 2a, a vehicle 100 is shown with a rear view 106 from a camera of the vehicle 100. This rear view 106 includes a view of a rear portion 108 of the vehicle periphery and optional parking guidance lines 110. This rear view 106 can be shown on a screen within the vehicle 100 or can be viewed through a configured mobile device. The rear view 106 can also be presented to the user of the vehicle 100 as a head-up display (HUD). Throughout this application the discussed mobile device can include a smart phone, a wearable computer such as a smart watch, a hand held device such as a tablet, a personal digital assistant (PDA), a notebook computer or any other movable computing device.

In FIG. 2b, the vehicle 100 is shown with an attachment 102 that has been placed on the vehicle. In this embodiment the attachment 102 is a bicycle. The one or more sensors have detected the size and the location of the attachment 102 on the vehicle 100 and have formed a representation 112 of the attachment 102 relative to the vehicle periphery. This representation 112 can be shown on a screen, or heads-up display (HUD) within the vehicle after a view provided by a camera is augmented with the attachment periphery, or the representation can be stored within a storage device within the vehicle so that both the attachment periphery can be monitored for distances between the attachment and an obstacle 104.

The representation 112 shown on a screen or HUD can be shown as a box or other polygon that approximates that periphery of the attachment 102 (as shown in FIG. 2b), or the representation 112 can be shown on a screen or HUD with a more accurate periphery of the attachment 102. Similarly, when the representation 112 is stored within a storage device within the vehicle, the representation 112 can be stored as a polygon that approximates the periphery of the attachment 102 or as a more accurate periphery of the attachment 102.

During operation of the vehicle 100 the one or more sensors monitor the surroundings of the vehicle 100 to determine if there are any obstacles 104 within a predetermined distance of the attachment periphery or the vehicle periphery. The one or more sensors can continuously monitor the surroundings, or monitor the surroundings in a predetermined interval. This predetermined distance can be variable based on the speed the vehicle 100 is travelling or this predetermined distance can be static.

If an object comes within the predetermined distance to either the attachment periphery or the vehicle periphery the method can optionally alert the user of the vehicle. This alert can be a visual alert on a screen within the vehicle 100 or can be viewed through a configured mobile device. The visual alert can also be presented as an alert in a heads-up display (HUD) within the vehicle. This alert can also be an audible alert through a speaker within the vehicle 100. Also, this alert can be a combination of a visual alert and an audible alert. In other embodiments, the vehicle 100 can act based on an object coming within a predetermined distance to either the attachment periphery or the vehicle periphery by automatically applying the brakes.

In this monitoring step, the method can consider the direction the vehicle 100 is moving in. For example, if the vehicle 100 is moving in a forward direction at least one of a height of the attachment 102, a width of the attachment 102 and a length of the attachment 102 as part of the attachment periphery can be monitored for a distance between the attachment periphery and an obstacle 104 (where “width” and “length” here are along the width and length of the vehicle 100). Also, a height of the vehicle 100 and a width of the vehicle 100 as part of the vehicle periphery can be monitored for a distance between the attachment periphery and an obstacle 104.

A clearance height of an obstacle 104 or elevated structure can be determined in comparison to a height of the attachment periphery or the vehicle periphery by the one or more sensors within the vehicle 100. Also, a clearance height of an obstacle 104 or elevated structure can be determined by the vehicle 100, or a mobile device within the vehicle 100, in comparison to a height of the attachment periphery or the vehicle periphery, by accessing a clearance height database. For example, the clearance height database can have clearance height information for overpasses on a highway, in this example, the vehicle 100, or a mobile device within the vehicle 100, can determine prior to the vehicle 100 passing the underneath the overpass whether the height of the vehicle periphery and the height of an attachment periphery are below the clearance height. In this example the vehicle 100, or a mobile device within the vehicle 100, can include positioning capabilities (such as through a Global Positioning System) as well as access to a clearance height database within the vehicle 100, or a mobile device within the vehicle 100, or a remotely stored database through an internet connection.

As another example of the monitoring step, if the vehicle 100 is moving in a reverse direction, at least one of a height of the attachment 102, a width of the attachment 102 and a length of the attachment 102 as part of the attachment periphery can be monitored for a distance between the attachment periphery and an obstacle 104 (where “width” and “length” here are along the width and length of the vehicle 100).

FIG. 2 is a flow diagram illustrating a method for modifying a vehicle's periphery. Each of the steps of the method can be accomplished by one or more processors within the vehicle's integrated computing system, or can be accomplished by one or more processors in a portable computing device that receive input from the vehicle's computing system.

Initially, in step 114 a notification is received by the vehicle 100 that an attachment 102 has been placed on the vehicle 100. Next, in step 116, one or more sensors that are located in or on the vehicle detect the location and size of the attachment on the vehicle.

In step 118 an attachment periphery of the attachment's size and location on the vehicle is formed. Based on this attachment periphery, a representation of the attachment periphery relative to the vehicle periphery is formed in step 120.

In step 122 the one or more sensors of the vehicle 100 monitor the vehicle 100′s surroundings to determine if there are any obstacles 104 within a predetermined distance of the attachment periphery or the vehicle periphery.

In optional step 124 the surroundings continue to be monitored and it is determined whether or not there is an obstacle 104 within a predetermined distance of the vehicle periphery or the attachment periphery.

In optional step 124, if the answer is no, that there are no obstacles 104 within a predetermined distance of the vehicle periphery or the attachment periphery, the method loops back and again determines whether or not there is an obstacle 104 within a predetermined distance of the vehicle periphery or the attachment periphery.

In optional step 124, if the answer is yes, that there are obstacles 104 within a predetermined distance of the vehicle periphery or the attachment periphery, the user of the vehicle 100 can be provided with an alert to notify them of the presence of the obstacle 104 within the predetermined distance.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can he rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

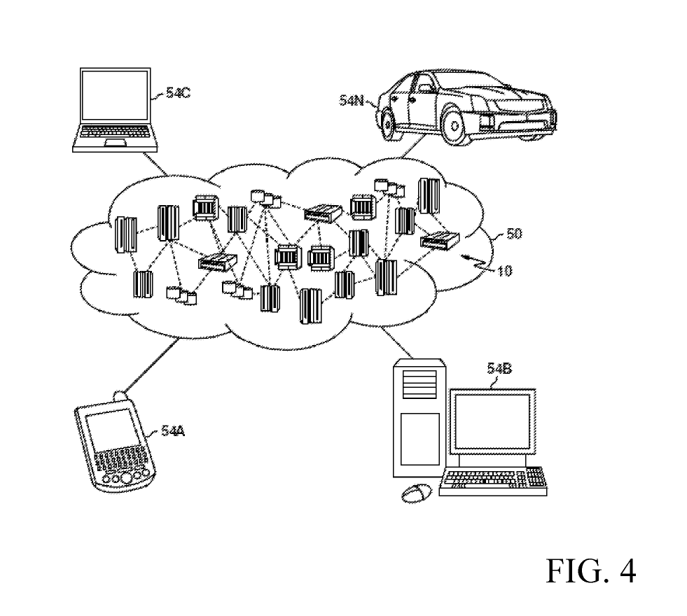

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

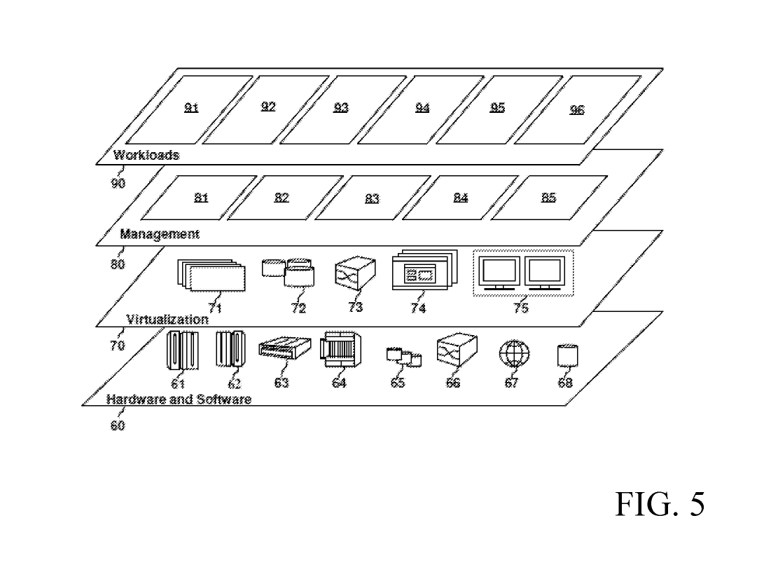

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and modifying a vehicle periphery 96.

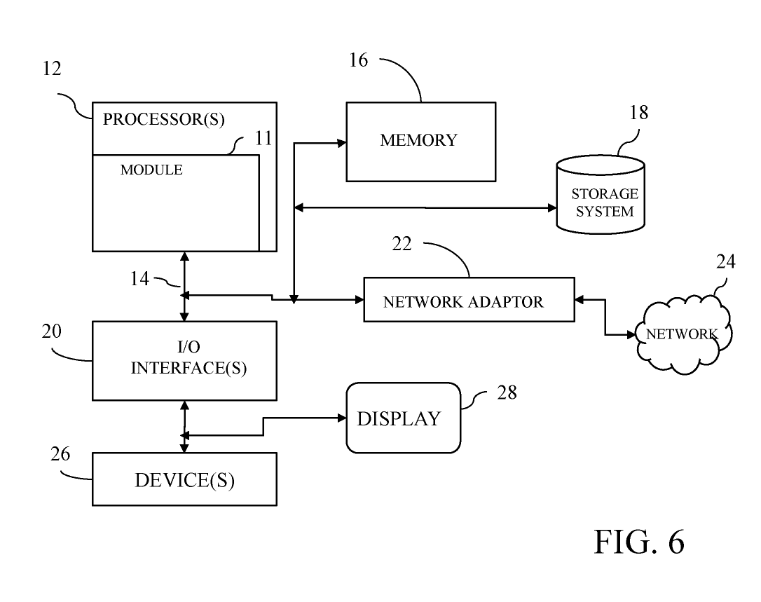

FIG. 6 illustrates a schematic of an example computer or processing system according to an embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 11 that performs the methods described herein. The module 11 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may he connected to the user's computer through any type of network, including a local area network (LAN) or a wide area network (WAN), or the connection may be made to an external computer (for example, through the Internet using an Internet Service Provider). In sonic embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for modifying a vehicle periphery of a vehicle comprising:
receiving a notification that an attachment is placed on the vehicle;
detecting, with one or more sensors located in or on the vehicle, the location and size of the attachment on the vehicle;
forming an attachment periphery of the attachment's size and location;
forming a representation of the attachment periphery relative to the vehicle periphery; and
monitoring, with the one or more sensors, the surroundings of the vehicle to determine if an obstacle is within a predetermined distance of the attachment periphery or the vehicle periphery.

2. The computer implemented method of claim 1, wherein the notification is inputted by a user or the notification is automatically determined by the one or more sensors.

3. The computer implemented method of claim 1, further comprising alerting the user of the vehicle when an obstacle is within the predetermined distance of the attachment periphery or the vehicle periphery.

4. The computer implemented method of claim 1, wherein in response to the vehicle moving in a forward direction, the monitoring step includes monitoring along at least one of a height of the attachment, a width of the attachment and a length of the attachment.

5. The computer implemented method of claim 4, wherein a clearance height of an obstacle is determined by the one or more sensors and/or by accessing a clearance height database.

6. The computer implemented method of claim 1, wherein in response to the vehicle moving in a reverse direction, the monitoring step includes monitoring along at least one of a height of the attachment, a length of the attachment and a width of the attachment.

7. The computer implemented method of claim 1, further comprising a step of adding the representation of the attachment periphery to an image captured by a camera of the vehicle after the forming the representation step and a step of displaying the image and the representation to a user of the vehicle.

8. The computer implemented method of claim 1, wherein software for performing the method is provided as a service on a cloud environment.

9. A system of modifying a vehicle periphery, comprising:
one or more storage devices;
one or more hardware processors coupled to the one or more storage devices;
the one or more hardware processors operable to receive a notification that an attachment is placed on the vehicle;
the one or more hardware processors operable to detect, with one or more sensors located in or on the vehicle, the location and size of the attachment on the vehicle;
the one or more hardware processors operable to form an attachment periphery of the attachment's size and location;
the one or more hardware processors operable to form a representation of the attachment periphery relative to the vehicle periphery; and
the one or more hardware processors operable to monitor, with the one or more sensors, the surroundings of the vehicle to determine if an obstacle is within a predetermined distance of the attachment periphery or the vehicle periphery.

10. The system of claim 9, wherein the notification is inputted by a user or the notification is automatically determined by the one or more sensors.

11. The system of claim 9, wherein the one or more hardware processors are operable to alert the user of the vehicle when an obstacle is within the predetermined distance of the attachment periphery or the vehicle periphery.

12. The system of claim 9, wherein when the vehicle is moving in a forward direction the monitoring step includes monitoring along at least one of a height of the attachment,a width of the attachment and a length of the attachment.

13. The system of claim 12, wherein a clearance height of an obstacle is determined by the one or more sensors and/or by accessing a clearance height database.

14. The system of claim 9, wherein when the vehicle is moving in a reverse direction the monitoring step includes monitoring along at least one of a height of the attachment, a length of the attachment and a width of the attachment.

15. The system of claim 9, wherein the one or more hardware processors are operable to add the representation of the attachment periphery to an image captured by a camera of the vehicle after the forming the representation step and are operable to display the image and the representation to a user of the vehicle.

16. A computereadable storage medium storing a program of instructions executable by a machine to perform a method of modifying a vehicle periphery, the method comprising:
receiving a notification that an attachment is placed on the vehicle;
detecting, with one or more sensors located in or on the vehicle, the location and size of the attachment on the vehicle;
forming an attachment periphery of the attachment's size and location;
forming a representation of the attachment periphery relative to the vehicle periphery; and
monitoring, with the one or more sensors, the surroundings of the vehicle to determine if an obstacle is within a predetermined distance of the attachment periphery or the vehicle periphery.

17. The computer readable storage medium of claim 16, further comprising alerting the user of the vehicle when an obstacle is within the predetermined distance of the attachment periphery or the vehicle periphery.

18. The computer readable storage medium of claim 16, wherein when the vehicle is moving in a forward direction the monitoring step includes monitoring along at least one of a height of the attachment, a width of the attachment and a length of the attachment.

19. The computer readable storage medium of claim 18, wherein a clearance height of an obstacle is determined by the one or more sensors and/or by accessing a clearance height database.

20. The computer readable storage medium of claim 16, further comprising a step of adding the representation of the attachment periphery to an image captured by a camera of the vehicle after the forming the representation step and a step of displaying the image and the representation to a user of the vehicle.
